(19) United States
(12) Patent Application Publication
(10) Pub. No.: US 2009/0296803 A1
(43) Pub. Date: Dec. 3, 2009

(54) BLOCK-BASED EQUALIZER AND METHOD THEREOF

(75) Inventors: Wei-Ting WANG, Yilan County (TW); Ming-Luen LIOU, Taipei County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 12/132,134

(22) Filed: Jun. 3, 2008

(51) Int. Cl. H04L 27/01

(52) U.S. Cl. 375/233

(57) ABSTRACT

A block-based equalizer used in a receiver, comprising a feed forward filter, a feed backward filter and a combiner. The feed forward filter generates one first data block for each round and each first data block has multiple first sub-blocks. The feed backward filter generates one second data block. Certain input symbols of the feed backward filter are suppressed during filtering. The combiner combines one second data block and one first sub-block.

### BACKGROUND

The invention relates to equalization and particularly relates to equalization being processed block by block.

To compensate the effects of a band-limited transmission channel, many digital data communication systems employ an equalizer to remove inter-symbol interference (ISI) in the received signal. ISI causes the value of a given symbol to be distorted by the values of preceding and following symbols, and essentially represents symbol “ghosts” since ISI includes advanced and delayed symbols with respect to a reference symbol location in a given decision region. These distortions limit the data rate efficiencies for communication over such channels. Accordingly, reducing the effect of such channel distortions is a subject of great interest.

### SUMMARY

A block-based equalizer used in a receiver, comprising: a feed forward filter for generating one first data block for each round, each first data block comprising a plurality of first sub-blocks, each first data block and each first sub-block having L symbols and K symbols respectively, where L and K are both bigger than one; a feed backward filter for generating one second data block for each iteration, each second data block having K symbols, the feed backward filter suppressing last K input symbols during filtering in each iteration; and a combiner for combining one second data block and one first sub-block for each iteration, the first sub-blocks in one round being combined separately by the combiner after multiple iterations.

A method for performing block-based equalization, comprising: generating one first data block for each round with a feed forward filter, each first data block comprising a plurality of first sub-blocks, each first data block and each first sub-block having L symbols and K symbols respectively, where L and K are both bigger than one; generating one second data block for each iteration with a feed backward filter, each second data block having K symbols, wherein the feed backward filter suppresses last K input symbols of the feed backward filter in each iteration; and combining one second data block and one first sub-block for each iteration with a combiner, wherein the first sub-blocks in one round are combined separately by the combiner after multiple iterations.

### BRIEF DESCRIPTION OF THE DRAWINGS

The invention can be more fully understood by reading the subsequent detailed description and examples with references made to the accompanying drawings, wherein:

FIG. 1 illustrates an embodiment of a block-based equalizer;

FIG. 2 illustrates an example of a feed backward filter;

FIG. 3 illustrates data flow in a first iteration in the block-based equalizer of FIG. 1;

FIG. 4 illustrates data flow in a second iteration in the block-based equalizer of FIG. 1;

FIG. 5 illustrates data flow in a third iteration in the block-based equalizer in FIG. 1; and

FIG. 6 illustrates a flowchart of a block-based equalization method.

### DETAILED DESCRIPTION

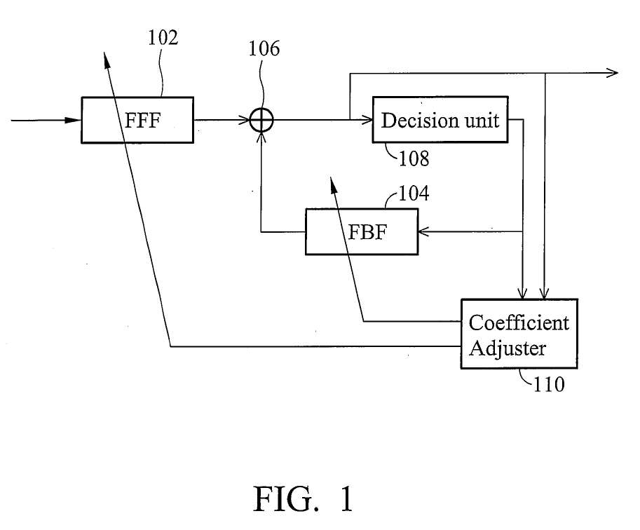

FIG. 1 illustrates a block-based equalizer as an embodiment according to the present invention. The block-based equalizer includes a feed forward filter (FFF) 102, a feed backward filter (FBF) 104, a combiner 106, a decision unit 108 and a coefficient adjuster 110. The block-equalizer can be used in a receiver in various applications, e.g. a wireless broadcasting program receiver to eliminate inter-symbol-interference (ISI) during data transmission.

Symbols are input to the FFF 102 in block base. In other words, there are two or more than two symbols forming a data block supplying to the FFF 102 in each round, i.e. an operation unit. For each round, the FFF 102 filters the input symbols and generates one first data block. One first data block is further divided into multiple first sub-blocks. Suppose one first data block has L symbols and one first sub-block has K symbols, L and K are both bigger than one.

In the block-based equalizer, multiple iterations of combining and filtering are performed with the combiner 106 and the FBF 104 in one round for handling one first data block. In each iteration, the FBF 104 generates one second data block that has K symbols. In addition, the combiner 106 combines one second data block and one first sub-block in each iteration. The combined output is supplied to the decision unit 108 which may be implemented with a slicer or other decision circuit commonly used in filter design field. Decision values generated by the decision unit 108 are supplied to the FBF 104 as input symbols. Besides, the combined output and the decision values are also supplied to the coefficient adjuster 110 to estimate errors so as to determine how to adjust the filter coefficients of the FFF 102 and the FBF 104 during equalization.

In the first iteration for handling one first data block, when the combined output are not generated yet, the FBF 104 do not have meaningful input symbols corresponding to the current first block in the current round. To overcome this problem, last K input symbols are suppressed in the FBF 104 during filtering. In other words, if there are M input symbols sequentially supplied to the FBF 104 during operation where M is bigger than K, the newest K input symbols are suppressed during filtering so that these newest K input symbols do not affect output of the FBF 104. When there are newer symbols supplied to the FBF 104, another newer K input symbols are suppressed during filtering of the FBF 104.

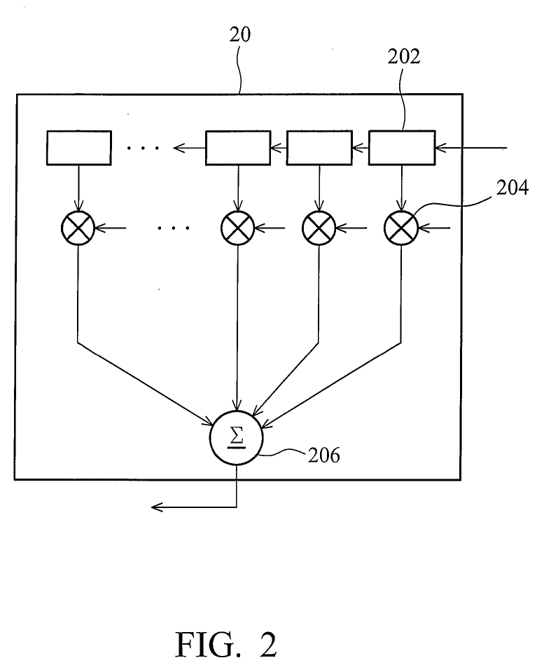

FIG. 2 is an exemplary finite impulse response (FIR) filter 20 as an example of the FBF 104 to illustrate a method to suppress last K input symbols. When an input symbol arrives at the FIR filter 20, the input symbol is entered to a tap 202, which is a storage unit, in a delay line. The value in the tap 202 is shifted to its adjacent tap if new input symbol arrives at the delay line. The value in each tap 202 is multiplied by a corresponding tap coefficient with a multiplier 204 and then multiplied values are summed with a summation unit 206 for generating filtered output.

If there are M taps in the delay line, K input symbols that are close to the input end of the FIR filter 20 are suppressed during filtering. For example, K tap coefficients corresponding to the K input symbols are set as zeros while other tap coefficients are adjusted by a coefficient adjuster like the one illustrated in FIG. 1. Alternatively, multipliers corresponding to the K input symbols near the input end of the FIR filter 20 can be replaced with zero registers that supply zeroes to the summation unit 206 directly. With such configuration, no matter what values the K input symbols are, they do not affect the filtered output until there are new symbols entered the delay line to occupy corresponding K taps.

In addition to adopt a FIR filter as illustrated in FIG. 2, it is possible to use a frequency domain filter in the embodiment as illustrated in FIG. 1. For example, the FBF 104 and/or the FFF 102 may contain a time domain to frequency domain converter to transform input symbols of time domain to frequency domain for performing filtering in the FBF 104 and/or the FFF 102. When frequency domain filter is adopted, corresponding conversion for suppressing the K input symbols of time domain in the FBF 104 is necessary. For example, a FIR filter may be configured first while setting K tap coefficients as zeroes as mentioned above and a time domain to frequency domain conversion is adopted to get the corresponding frequency domain filter. Since it is already known to persons skilled in the art to perform time domain FIR filtering in frequency domain, detailed formula are not provided here for clarity.

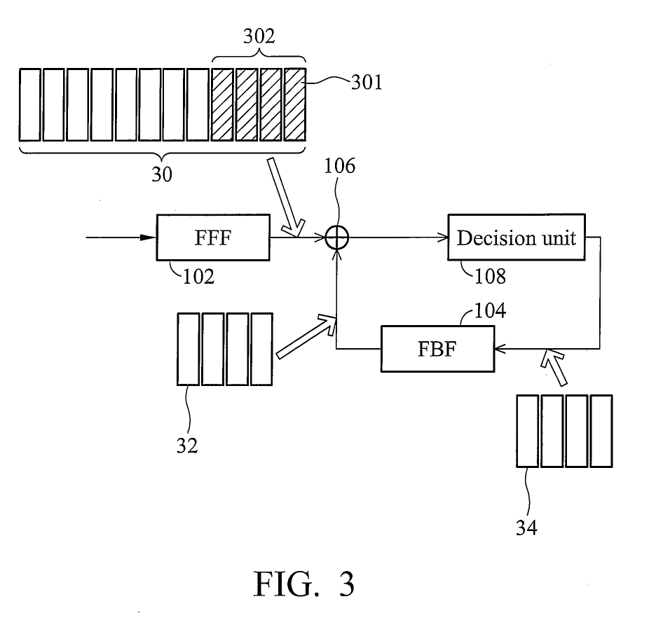

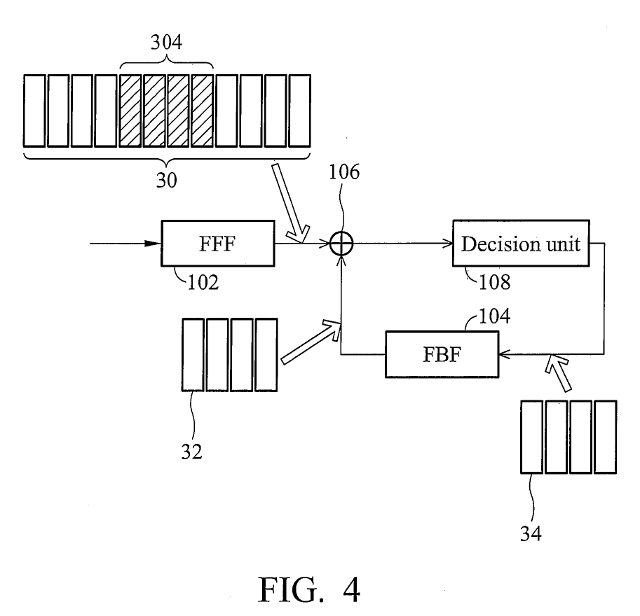

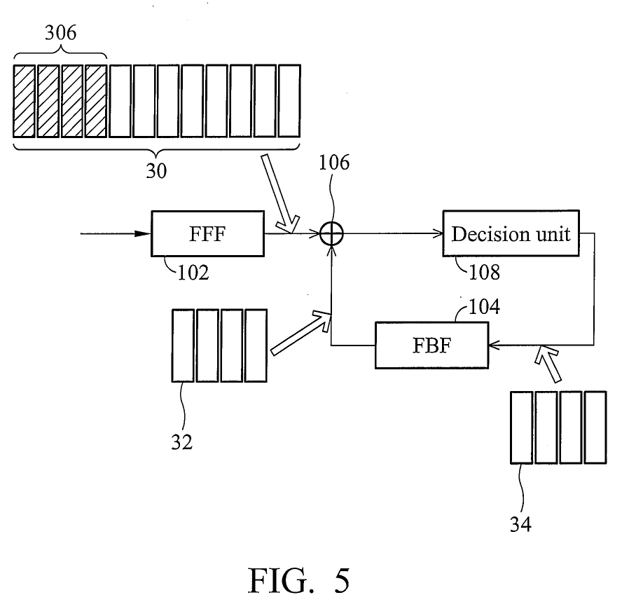

FIG. 3, FIG. 4 and FIG. 5 illustrate data block relation during multiple iterations in one round. Reference numerals identical to those in FIG. 1 indicate they represent the same elements. In FIG. 3, one first data block 30 includes multiple first sub-blocks, e.g. the sub-block 302. For clarity, each rectangle refers to certain number of symbols. For example, the rectangle 301 may indicate 100 or 1,000 symbols, depending on different equalizer design requirements. If one first data block has L symbols and one first sub-block has K symbols, it needs L/K (L divides K) or more iterations to handle the whole first data block in one round.

In FIG. 3, which illustrates the first iteration in the first round, the FBF 104 does not receive decision values 34 yet, the second data block 32 may be set as zeroes to be combined with one first sub-block 302 of the first data block 30. The combined values calculated by the combiner 106 are supplied to the decision 108 to generate K decision values 34 as input for the FBF. Consequently, in the end of the first iteration, the FBF 104 generates one second data block 32 to be used in the second iteration.

In FIG. 4, which illustrates the second iteration in the first round, one next first sub-block 304 is combined with the second data block 32 that is generated in the first iteration. Similarly, the combiner 106 combines the first sub-block 304 and the second data block 32 and the decision unit 108 provides decision values to the FBF 104 to generate another new second data block 32 to be used in the third iteration.

In FIG. 5, one next first sub-block is combined with the second data block 32 to generate yet another new second data block 32. Consequently, after three iterations in this example, the whole first data block is processed and equalization output of the same number of symbols is obtained. When a new round begins, another first data block is supplied and the operation steps as illustrated above may be run again.

With the design as mentioned above, initialization problem of block equalization is solved and applying block equalization usually brings better efficiency and performance. Since equalizer usually occupies big area in a receiver circuit, such design improves overall performance of a receiver.

The FFF 102, the FBF 104, the combiner 106 and other elements mentioned above may be implemented in a digital signal processing circuit, which may be part of an integrated chip for handling data receiving and other functions. There are various ways, e.g. hardware, firmware, software or their combination, to implement the above design and should be considered within the scope of the invention. Besides, although FIG. 1 illustrates an applicable structure of a block-based equalizer, some components, e.g. the decision unit 108, the coefficient adjuster 110 in FIG. 1 may be rearranged with their connection with other components. For example, the output of the combiner 106 may be supplied as equalization output as illustrated in FIG. 1. Alternatively, a multiplexer may be added to select either the output of the combiner 106 or the output of the decision unit 108 as equalization output. Besides, the example mentioned above illustrates that in one round, there are L/K (L divides K) iterations necessary to handle one first data block, but it should be not be regarded as a limitation of the invention. For example, there may be more than L/K iterations, e.g. 2L/K iterations to do it again, performed before equalization output is generated to gain better performance.

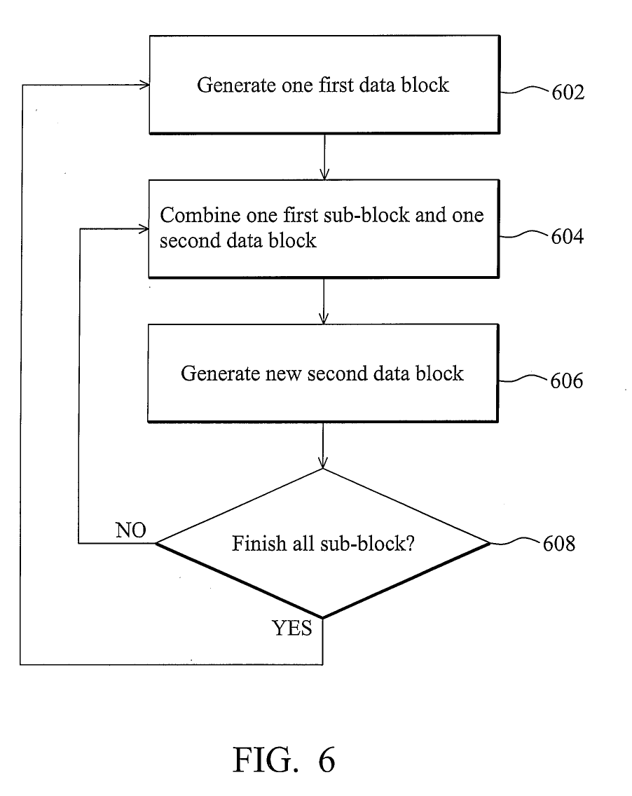

FIG. 6 is a flowchart illustrates a block-based equalization method. First, one first data block for each round is generated with a feed forward filter (step 602). Each first data block includes a plurality of first sub-blocks. Each first data block and each first sub-block has L symbols and K symbols respectively, where L and K are both bigger than one.

One second data block and one first sub-block for each iteration is combined with a combiner (step 604). If no second data block is generated yet, initial values are assigned to be combined with the first sub-block.

Next, one second data block for each iteration with a feed backward filter is generated (step 606). Each second data block has K symbols. In addition, the feed backward filter suppresses last K input symbols of the feed backward filter in each iteration.

If there are still first sub-blocks not handled, a new iteration is performed (step 608). Otherwise, a new round is activated to process another first data block.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A block-based equalizer used in a receiver, comprising:
a feed forward filter for generating one first data block for each round, each first data block comprising a plurality of first sub-blocks, each first data block and each first sub-block having L symbols and K symbols respectively, where L and K are both bigger than one;
a feed backward filter for generating one second data block for each iteration, each second data block having K symbols, the feed backward filter suppressing last K input symbols during filtering in each iteration; and
a combiner for combining one second data block and one first sub-block for each iteration, the first sub-blocks in one round being combined separately by the combiner after multiple iterations.

2. The block-based equalizer used in the receiver of claim 1, wherein the feed backward filter is a finite impulse response filter that has K tap coefficients counted from the input end of the finite impulse response filter being set as zeros.

3. The block-based equalizer used in the receiver of claim 1, wherein the feed backward filter is a finite impulse response filter that has K taps counted from the input end of the finite impulse response filter being suppressed so as not to affect output of the finite impulse response filter.

4. The block-based equalizer used in the receiver of claim 1, wherein the feed backward transforms input symbols of the feed backward filter to frequency domain and performs filtering in frequency domain.

5. The block-based equalizer used in the receiver of claim 1, further comprising:
a decision unit for receiving output of the combiner and supplying decision values to the feed backward filter.

6. The block-based equalizer used in the receiver of claim 5, further comprising:
a coefficient adjuster for receiving output of the combiner and the decision unit to adjust coefficients of the feed forward filter and the feed backward filter.

7. The block-based equalizer used in the receiver of claim 1, wherein the feed forward filter, the feed backward filter, and the combiner are implemented within a digital signal processing circuit.

8. The block-based equalizer used in the receiver of claim 1, wherein the receiver is a wireless broadcasting program receiver.

9. A method for performing block-based equalization, comprising:
generating one first data block for each round with a feed forward filter, each first data block comprising a plurality of first sub-blocks, each first data block and each first sub-block having L symbols and K symbols respectively, where L and K are both bigger than one;
generating one second data block for each iteration with a feed backward filter, each second data block having K symbols, wherein the feed backward filter suppresses last K input symbols of the feed backward filter in each iteration; and
combining one second data block and one first sub-block for each iteration with a combiner, wherein the first sub-blocks in one round are combined separately by the combiner after multiple iterations.

10. The method for performing block-based equalization of claim 9, wherein the feed backward filter is a finite impulse response filter that has K tap coefficients counted from the input end of the finite impulse response filter being set as zeros.

11. The method for performing block-based equalization of claim 9, wherein the feed backward filter is a finite impulse response filter that has K taps counted from the input end of the finite impulse response filter being suppressed so as not to affect output of the finite impulse response filter.

12. The method for performing block-based equalization of claim 9, further comprising:
transforming input symbols of the feed backward filter to frequency domain and performs filtering of the feed backward filter in frequency domain.

13. The method for performing block-based equalization of claim 9, further comprising:
supplying decision values to the feed backward filter with a decision unit that receives output of the combiner.

14. The method for performing block-based equalization of claim 13, further comprising:
adjusting coefficients of the feed forward filter and the feed backward filter according to output of the combiner and the decision unit.

15. The method for performing block-based equalization of claim 9, wherein the feed forward filter, the feed backward filter, and the combiner are implemented within a digital signal processing circuit.

16. The method for performing block-based equalization of claim 9, wherein the receiver is a wireless broadcasting program receiver.
